(19) United States
(12) Patent Application Publication
(10) Pub. No.: US 2017/0091813 A1
(43) Pub. Date: Mar. 30, 2017

(54) TARGETING ANALYSIS WITH SKILLS DATA

(71) Applicant: Linkedln Corporation, Mountain View, CA (US)

(72) Inventors: Sophia Li-Ming Wong, San Mateo, CA (US); Jimmy K. Wong, San Mateo, CA (US); David Harris Karel, Palo Alto, CA (US)

(21) Appl. No.: 14/871,441

(22) Filed: Sep. 30, 2015

(51) Int. Cl. G06Q 30/02; G06Q 10/06; G06N 99/00; G06Q 50/00

(52) U.S. Cl. CPC G06Q 30/0254; G06Q 50/01; G06Q 10/067; G06N 99/005

(57) ABSTRACT

A computer-implemented method includes identifying a first set of members on a social network, each member of the first set of members includes a class value comprising one of a positive member and a negative member, each positive member is associated with a target offering, determining a skillset of each member of the first set of members, training a first model based on the class value and skillset of each member of the first set of members, the first model configured to generate at least one of a classification value and a prospect score for a prospect member based on a prospect member skillset, computing a prospect score for the prospect member using the first model and the prospect member skillset, and providing the at least one of a classification value and a prospect score for use in evaluating the prospect member in relation to the target offering.

### TECHNICAL FIELD

This application relates generally to the technical field of skills analysis in a social network and, in one specific example, to systems and methods for providing targeting analysis based on skills data.

### BACKGROUND

Online advertising is a form of marketing and advertising which uses the Internet to deliver promotional marketing messages to consumers. Online marketing channels include email marketing, search engine marketing, social media marketing, mobile advertising, and so on.

### BRIEF DESCRIPTION OF THE DRAWINGS

Some embodiments are illustrated by way of example and not limitation in the figures of the accompanying drawings.

FIG. 1 is a network diagram illustrating a network environment suitable for a social network service implementing a skills analysis engine, according to some example embodiments.

FIG. 2 is a block diagram illustrating components of an example social network system (e.g., providing the social network service(s)), according to some example embodiments.

FIG. 3 is a diagram of the example skills analysis engine shown in FIG. 2.

FIG. 4 is a flow chart illustrating operations of the skills analysis engine in performing a method for providing targeting analysis with skills data in a social network, according to various embodiments.

FIG. 5 is a block diagram illustrating components of a machine, according to some example embodiments, able to read instructions from a machine-readable medium and perform any one or more of the methodologies discussed herein.

### DETAILED DESCRIPTION

Example methods and systems are directed to techniques for providing targeting analysis with skills data. More specifically, the present disclosure relates to methods, systems, and computer program products for mapping skillsets of social network members to products for assessing marketing prospects, or leads, and improving product-market fit in online marketing channels (e.g., assessing a level of a prospect's readiness to purchase). Knowing the product-market fit of existing customers and prospective customers may provide an advantage to sales and marketing professionals, for example, in deciding whether to engage with a prospect with a relevant offer, thereby enabling the sales and marketing professionals to focus on only the best prospects with enhanced probability of success to sell, cross-sell, or upsell.

A marketer or advertiser offers a product or service (“target offering”) to prospective customers or buyers (e.g., members) in a social network. The marketer seeks “leads” from a social network service, or help in identifying higher-value prospective customers of the target offering. Some leads may be of higher value than others, or represent greater potential in some way to the marketer. For example, some members of the social network service may have no interest in the target offering, and are thus of little or no value to the marketer as a lead. Other members may have mild interest in the target offering, but may be of lesser value to the marketer as a lead because, for example, they may be more difficult to convince to further investigate the target offering, or to purchase the target offering (e.g., requiring greater advertising effort per lead), or even if they did purchase the target offering, the amount they may be able or willing to spend on the target offering may be minimal (e.g., disproportionally small gain as compared to amount spent advertising to them). Still other members may be higher value leads for the marketer because, for example, they are the type of member that may have high interest in the target offering, or may have larger budgets at their disposal for expenditure on the target offering, and so on.

Further, the marketer may be presented with a plurality of communications channels made available via the social network service and through which leads may be pursued, such as text-based ads (e.g., text ads appearing on a side section of members' social network interfaces), display ads (e.g., ads including a mix of text, images, and links to deeper content, and appearing within members' social network interfaces), in-network email-based ads (e.g., email advertisements sent directly to members' social network email accounts), sponsored updates ads (e.g., ads appearing within a main content section (e.g., a feed) of members' social network interfaces, and so forth.

The social network service includes a skills analysis engine, described herein, that analyzes product-market fit between members and the target offering based on members' skills data from the social network service. The skills analysis engine leverages members' skills data (e.g., areas of work experience) from the social network service to identify higher-value leads for the marketer. Further, the skills analysis engine may also leverage historical usage of communications channels (e.g., in relation to skills data) to further identify or rank which channels may be better to generate leads than others.

More specifically, the marketer (or the social network on behalf of the marketer) identifies a set of “positive customers/members” (a positive set, or positive members) that have had positive interaction with the target offering in the past (e.g., members that previously purchased the target offering and have provided positive feedback from their experience, or members that have spent significant sums or conducted repeated transactions on the target offering). Further, the skills analysis engine and/or the marketer may identify a set of negative, neutral, or random members (negative set, negative members). In some embodiments, the skills analysis engine compares skills data of the positive members to skills data of the negative members to identify a set of “target skills,” or skills that may be indicative of higher-value leads. In other embodiments, the skills analysis engine trains a machine learning model using the positive and negative members' data. The skills analysis engine then uses the set of target skills and/or the model to identify leads for the marketer within the social network service, for example, by ranking or scoring members based on the set of target skills and, for example, identifying members that score above a pre-determined threshold as leads for the marketer.

Further, multiple sets of member data may be provided or identified, where each set of member data is segmented based on the communications channels of the social network. The skills analysis engine may generate separate sets of target skills, or separate models, for each communications channel of the social network. For example, text ads may have a different set of target skills (or a different ranking of the same set of target skills), than sponsored updates. In other words, different types of people (e.g., by skill sets) may respond better to one communications channel than they do to another.

Examples merely demonstrate possible variations. Unless explicitly stated otherwise, components and functions are optional and may be combined or subdivided, and operations may vary in sequence or be combined or subdivided. In the following description, for purposes of explanation, numerous specific details are set forth to provide a thorough understanding of example embodiments. It will be evident to one skilled in the art, however, that the present subject matter may be practiced without these specific details.

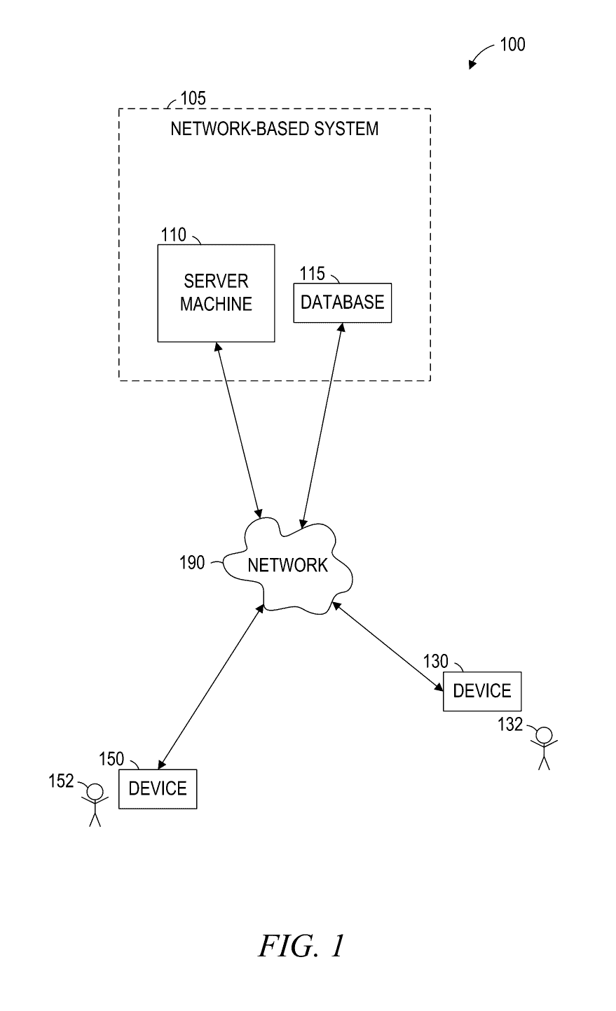

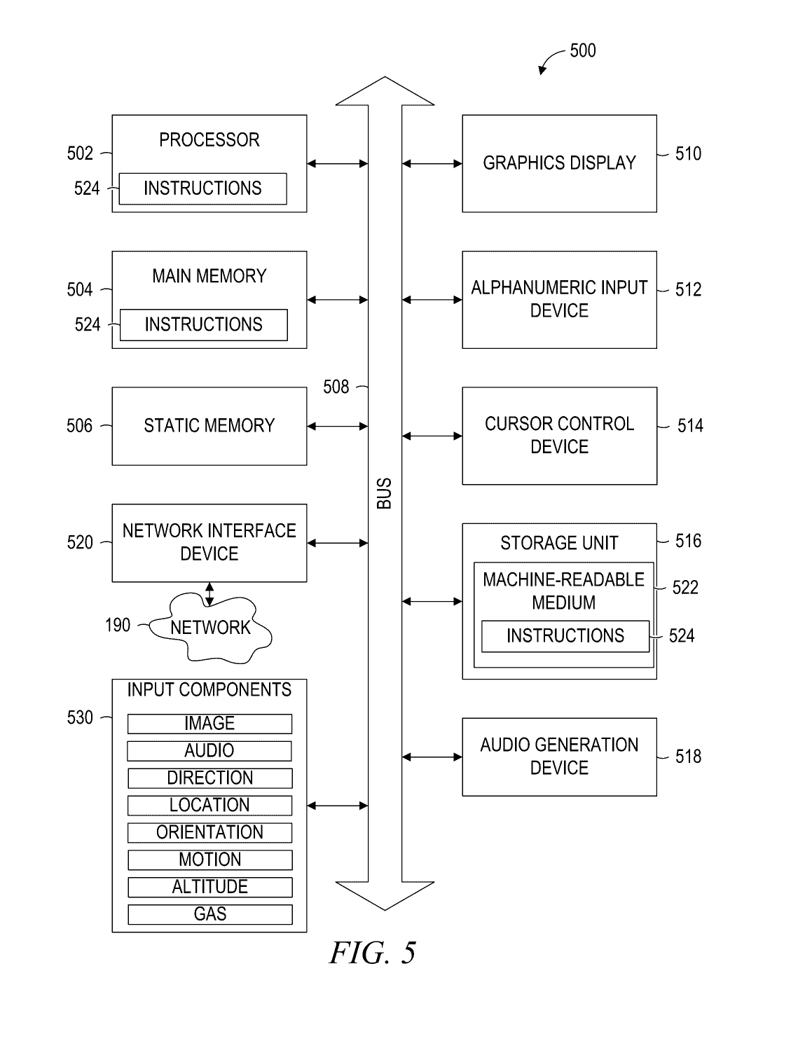

FIG. 1 is a network diagram illustrating a network environment 100 suitable for a social network service implementing a skills analysis engine (not separately shown in FIG. 1), according to some example embodiments. The network environment 100 includes a server machine 110, a database 115, a first device 130 for a first user 132, and a second device 150 for a second user 152, all communicatively coupled to each other via a network 190. The server machine 110 and the database 115 may form all or part of a network-based system 105 (e.g., a cloud-based server system configured to provide one or more services to the devices 130 and 150) that may also provide the skills analysis engine described herein. The database 115 can store member data (e.g., profile data, social graph data) for the social network service. The server machine 110, the first device 130, and the second device 150 may each be implemented in a computer system, in whole or in part, as described below with respect to FIG. 5.

Also shown in FIG. 1 are the users 132 and 152. One or both of the users 132 and 152 may be a human user (e.g., a human being), a machine user (e.g., a computer configured by a software program to interact with the device 130 or 150), or any suitable combination thereof (e.g., a human assisted by a machine or a machine supervised by a human). The user 132 is not part of the network environment 100, but is associated with the device 130 and may be a user of the device 130. For example, the device 130 may be a desktop computer, a vehicle computer, a tablet computer, a navigational device, a portable media device, a smartphone, or a wearable device (e.g., a smart watch or smart glasses) belonging to the user 132. Likewise, the user 152 is not part of the network environment 100, but is associated with the device 150. As an example, the device 150 may be a desktop computer, a vehicle computer, a tablet computer, a navigational device, a portable media device, a smartphone, or a wearable device (e.g., a smart watch or smart glasses) belonging to the user 152.

Any of the machines, databases 115, or devices 130, 150 shown in FIG. 1 may be implemented in a general-purpose computer modified (e.g., configured or programmed) by software (e.g., one or more software modules) to become a special-purpose computer configured to perform one or more of the functions described herein for that machine, database 115, or device 130, 150. For example, a computer system able to implement any one or more of the methodologies described herein is discussed below with respect to FIG. 5. As used herein, a “database” is a data storage resource and may store data structured as a text file, a table, a spreadsheet, a relational database (e.g., an object-relational database), a triple store, a hierarchical data store, or any suitable combination thereof. Moreover, any two or more of the machines, databases 115, or devices 130, 150 illustrated in FIG. 1 may be combined into a single machine, database 115, or device 130, 150, and the functions described herein for any single machine, database 115, or device 130, 150 may be subdivided among multiple machines, databases 115, or devices 130, 150.

The network 190 may be any network that enables communication between or among machines, databases 115, and devices (e.g., the server machine 110 and the device 130). Accordingly, the network 190 may be a wired network, a wireless network (e.g., a mobile or cellular network), or any suitable combination thereof. The network 190 may include one or more portions that constitute a private network, a public network (e.g., the Internet), or any suitable combination thereof. Accordingly, the network 190 may include one or more portions that incorporate a local area network (LAN), a wide area network (WAN), the Internet, a mobile telephone network (e.g., a cellular network), a wired telephone network (e.g., a plain old telephone system (POTS) network), a wireless data network (e.g., a Wi-Fi network or WiMAX network), or any suitable combination thereof. Any one or more portions of the network 190 may communicate information via a transmission medium. As used herein, “transmission medium” refers to any intangible (e.g., transitory) medium that is capable of communicating (e.g., transmitting) instructions for execution by a machine (e.g., by one or more processors of such a machine), and includes digital or analog communication signals or other intangible media to facilitate communication of such software.

In the example embodiment, the network-based system 105 provides lead generation services to the users 132, 152 of the social network service. Some users 132, 152 may be members of the social network service. Other users 132, 152 may be advertisers or marketers, and may provide content (e.g., advertisements) to the members of the social network service through communications channels provided by the social network service, as described herein. The skills analysis engine described herein may, thus, provide lead generation services to marketers while also providing relevant content to members.

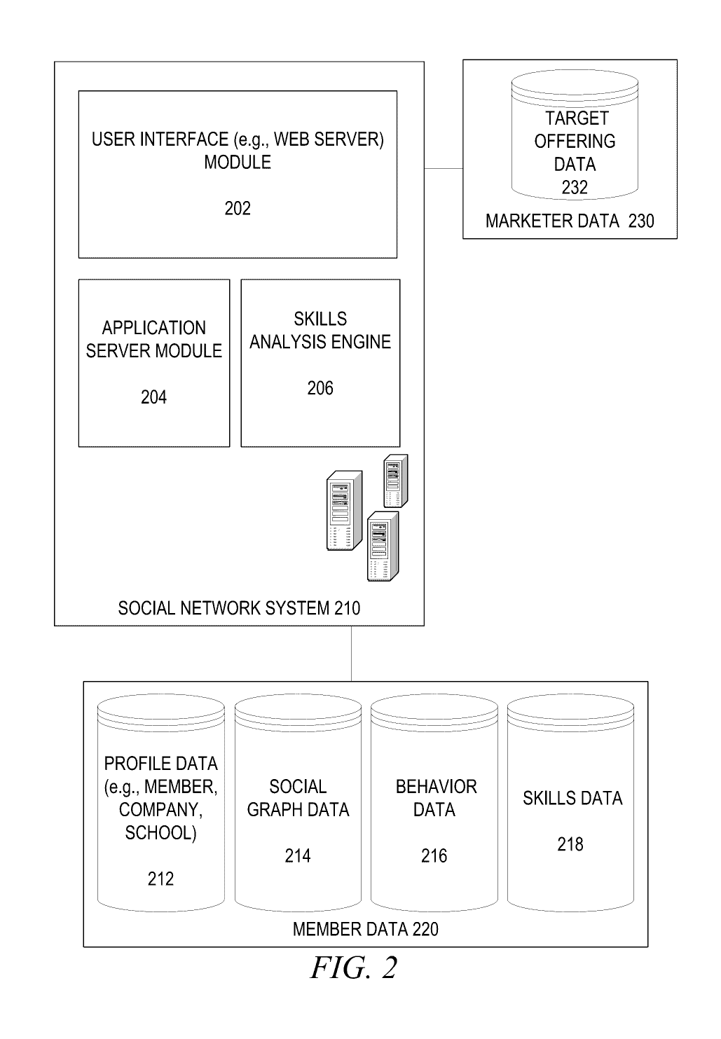

FIG. 2 is a block diagram illustrating components of an example social network system 210 (e.g., providing the social network service(s)), according to some example embodiments. The social network system 210 is an example of the network-based system 105 of FIG. 1. The social network system 210 includes a user interface module 202, an application server module 204, and a skills analysis engine 206, all configured to communicate with each other (e.g., via a bus, shared memory, a communications network, or the like).

The social network system 210 (e.g., as provided by the network-based system 105) may provide a broad range of applications and services (the “social networking service(s)”) that allow members (e.g., users 132 and 152) the opportunity to share and receive information, often customized to the interests of the targeted member. For example, the social networking service may include a photo sharing application that allows members to upload and share photos with other members. In some example embodiments, members may be able to self-organize into groups (e.g., interest groups) organized around a subject matter or topic of interest, or some of the social networking services may host various job listings providing details of job openings with various organizations (e.g., companies).

The social network system 210 communicates with the database 115 of FIG. 1, such as a database storing member data 220, and a database storing marketer data 230. The member data 220 can include profile data 212 (e.g., the member's employer, position, educational information, and so forth), social graph data 214 (e.g., contacts and connections with other members), behavior data 216 (e.g., actions performed within the social network, such as in-network mail, or interactions with in-network advertisements), and skills data 218 (e.g., job skills information, job descriptions of past and current employment positions, and so forth). For example, using profile data 212, behavior data 216, and/or skills data, the social network system 210 (e.g., the skills analysis engine 206) can determine higher-value leads for marketers (e.g., advertisers). The marketer data 230 can include target offering data 232 for the target offering of the marketer. For example, target offering data may include member interaction information associated with the target offering from historical interactions between members of the social network system 210 and the target offering (e.g., survey information, sales information, advertisement history, and other interactions between members and the target offering).

As shown in FIG. 2, database 115 can include several databases for member data 220. The member data 220 includes a database for storing the profile data 212, including both member profile data and profile data for various organizations. Additionally, the member data 220 can store the social graph data 214 and the behavior data 216.

The profile data 212 can include member attributes used in providing leads by the lead generation module 206. For instance, with many of the social network services provided by the social network system 210, when a user 132, 152 registers to become a member, the member is prompted to provide a variety of personal and employment information to be displayed in the member's personal web page. Such information is commonly referred to as member attributes. The member attributes that are commonly requested and displayed as part of a member's profile includes the member's age, birthdate, gender, interests, contact information, residential address, home town and/or state, spouse and/or family members, educational background (e.g., schools, majors, matriculation and/or graduation dates, etc.), employment history, office location, skills, professional organizations, and so on. In some embodiments, the member attributes may include the various skills that each member has indicated he or she possesses. Additionally, the member attributes may include skills for which a member has been endorsed.

With certain social network services, such as some business or professional network services, the member attributes may include information commonly included in a professional resume or curriculum vitae (CV), such as information about a person's education, the company at which a person is employed, the location of the employer, an industry in which a person is employed, a job title or function, an employment history, skills possessed by a person, professional organizations of which a person is a member, and so on.

Some of these member attributes may also be included as a part of skills data 218 (e.g., skills provided directly by the member), while other skills data 218 may be provided from other sources (e.g., skills for which the member has been endorsed, skills derived by the social network system 210 from job descriptions provided by the member for current and past employment, resume, CV, and so forth). Skills data 218 includes titles of skills for which the member is somehow associated (e.g., through past employment experience with the skill, through skills endorsements, and so forth). For purposes of the present disclosure, skills data 218 is presumed present, however received, entered, derived, or otherwise acquired.

Another example of the profile data 212 can include data associated with a company page. For example, when a representative of an entity initially registers the entity with the social network service, the representative may be prompted to provide certain information about the entity. This information may be stored, for example, in the database 115 and displayed on an entity page. This type of profile data 212 can also be used in the forecasting models described herein.

Additionally, social network services provide their users 132, 152 with a mechanism for defining their relationships with other people. This digital representation of real-world relationships is frequently referred to as a social graph.

In addition to hosting a vast amount of social graph data 214, many of the social network services offered by the social network system 210 maintain behavior data 216. The behavior data 216 can include an access log of when a member has accessed the social network system 210, profile page views, entity page views, newsfeed postings, interactions with target offerings (e.g., presentations of advertisements to the member), and clicking on links on the social network system 210. For example, the access log can include the last logon date, the frequency of using the social network system 210, and so on.

Additionally, the behavior data 216 can include information associated with applications and services that allow members the opportunity to share and receive information, often customized to the interests of the member. In some embodiments, members may be able to self-organize into groups, or interest groups, organized around subject matter or a topic of interest.

Any one or more of the modules or engines described herein may be implemented using hardware (e.g., one or more processors of a machine) or a combination of hardware and software. For example, any module or engine described herein may configure a processor (e.g., among one or more processors of a machine) to perform the operations described herein for that module. Moreover, any two or more of these modules may be combined into a single module, and the functions described herein for a single module may be subdivided among multiple modules. Furthermore, according to various example embodiments, modules described herein as being implemented within a single machine, database 115, or device 130, 150 may be distributed across multiple machines, databases 115, or devices 130, 150.

The target offering data 232 includes data associated with the target offering (e.g., the product or service that is the subject of advertising for the marketer as described herein). The target offering data 232 includes a positive set of members (e.g., positive classification or class value), or a set of members of the social network system 210 that have had a positive interaction with the target offering (e.g., in historical interactions with the target offering, such as through purchase history, or through advertisement interactions). For example, the positive set of members may include a set of members that have had positive interaction with the target offering in the past such as, for example, members that previously clicked on or purchased the target offering, downloading an online publication associated with the target offering (e.g., an e-book, a product brochure, or a whitepaper), or opting in for additional content or have subscribed for a service, or to ask for more information, or that have provided positive feedback from their experiences with the target offering, or members that have spent significant sums or conducted repeated transactions for the target offering. In some embodiments, the positive set of members includes member identifiers for each member identified in the positive set (e.g., an identifier unique to each member within the social network system 210).

In some embodiments, the target offering data 232 may also include communications channel data associated with the target offering. The social network system 210 may provide multiple communications channels, or marketing channels, for marketing the target offering to members, such as text-based ads (e.g., text ads appearing on a side section of members' social network interfaces), display ads (e.g., ads including a mix of text, images, and links to deeper content, and appearing within members' social network interfaces), in-network email-based ads (e.g., email advertisements sent directly to members' social network email accounts), sponsored updates ads (e.g., ads appearing within a main content section (e.g., a feed) of members' social network interfaces, organic search, paid search, and so forth. The communications channel data may include information indicative of how the positive members interacted with the target offering in the past (e.g., whether they purchased the target offering after being presented with a text ad for the target offering, or whether they inquired further into the target offering by clicking on a link within a sponsored update for the target offering). Further, in some embodiments, the target offering data 232 may be specific to a particular communications channel. In other words, certain types of interactions may be provided within certain communications channels that may not be available within other communications channels.

In some embodiments, aspects of the target offering data 232 (e.g., the positive set, the negative set) may be provided by the marketer. For example, the marketer may provide a list of past consumers (e.g., members) of the target offering as the positive set. In other embodiments, aspects of the target offering data 232 may be computed or determined by the social network system 210. For example, the social network system 210 may analyze interactions between the members of the social network service and the target offering (e.g., through historical advertisements presented to those members) and select members to form the positive set based on the historical interactions. As described above, members may be selected as a part of the positive set for based on a variety of types of interaction with the target offering such as, for example, the member had previously purchased the target offering and have provided positive feedback from their experience, or had previously spent significant sums or conducted repeated transactions for the target offering.

In some embodiments, target offering data 232 may also include a negative set of members (e.g., negative classification or class value), or a set of members that may be random members (e.g., not necessarily having any prior interaction with the target offering), or members that have had negative or neutral prior interaction with the target offering. The negative set may be used by the skills analysis engine 206, for example, as a control group to compare against the positive set when determining skills that may be used by the skills analysis engine 206 to identify higher-value leads for the marketer. In other words, the negative set members may not necessarily have had actual negative or non-positive interactions with the target offering.

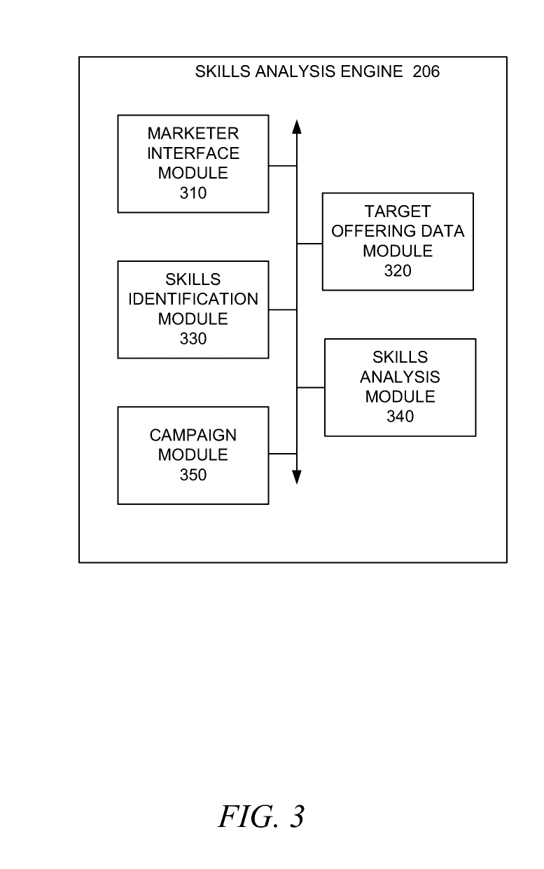

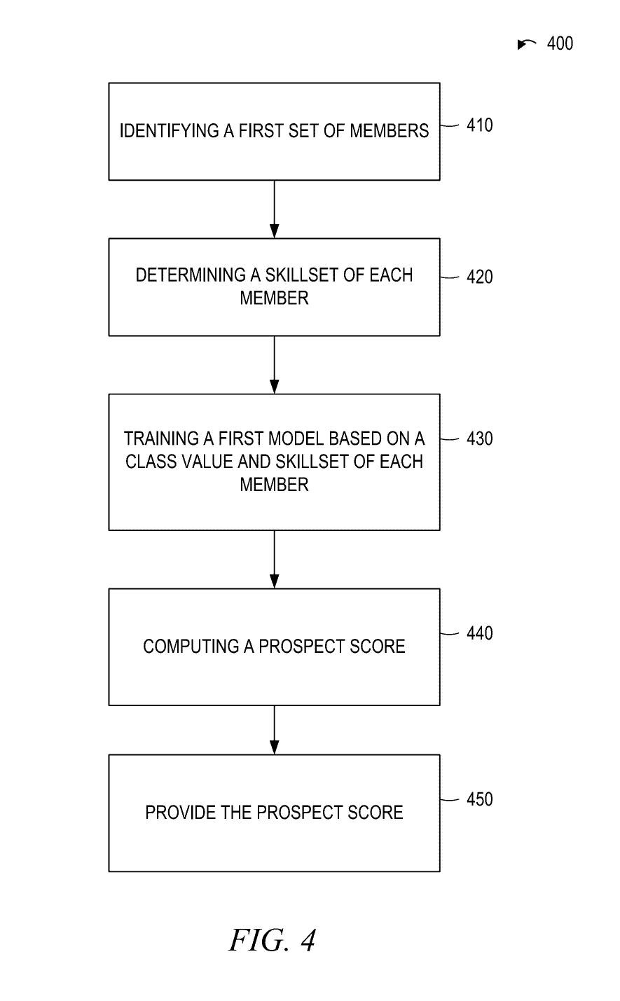

As will be further described with respect to FIGS. 3-4, the skills analysis engine 206, in conjunction with the user interface module 202 and the application server module 204, provides skills analysis services to the users 132, 152 (e.g., marketers and members) in the social network system 210 and associated services.

FIG. 3 is a diagram of the example skills analysis engine 206 shown in FIG. 2. In the example embodiment, the skills analysis engine 206 includes a marketer interface module 310, a target offering data module 320, a skills identification module 330, a skills analysis model 340, and a campaign module 350.

Marketers such as users 132, 152 interact with the skills analysis engine 206 through the marketer interface module 310. The marketer may identify or otherwise provide target offering data such as a positive and/or negative set of members of the social network system 210 for use by the skills analysis engine 206. Members in these marketer-input sets may be identified by member identifiers native to the social network system 210, or may be identified by alternate data about the member that may be correlated to member identifiers native to the social network system 210 (e.g., by the target offering data module 320). For example, the marketer may provide a list of people that have purchased their target offering or otherwise had positive interactions with their target offering (e.g., buyer names, perhaps from the marketer's e-commerce site), and/or a list of people that have had negative interactions with their target offering. The skills analysis engine 206 may correlate the buyer names to member IDs within the social network system 210, and thus enable use of the positive or negative members' skills data to facilitate the operations described herein.

The target offering data module 320 identifies the target offering data 232 (e.g., positive and negative set data, or training data), and may store such data in a database such as marketer data 230. In some embodiments, the target offering data module 320 may receive target offering data from the marketer (e.g., provided through the marketer interface module 310). For example, the marketer may provide the positive set of members to be used by the skills analysis engine 206, and may also provide the negative set of members. If the marketer has not provided a negative set, the target offering data module 320 may construct a negative set from random members.

In some embodiments, the target offering data module 320 may identify target offering data native to the marketing services provided by the social network system 210 (e.g., from member data 220). For example, the target offering data module 320 may identify positive members based on members' past use of the various communications channels made available by the social network system 210. In other words, the target offering may be the marketing features provided within the communications channels, and the members may be analyzed as to their relationship to those marketing features. As such, positive members may be identified as members that have established advertising campaigns within the social network system 210, or that have had repeated campaigns, or that have had campaigns with a certain minimum threshold of success (e.g., favorable responses to the advertising campaign by other members), or a certain spending amount (e.g., higher dollar amounts generally indicating greater positivity for the member), or how long the member has been on the social network system 210, or particular skills of the members (e.g., skills identified as influential in a previous iteration, by the skills analysis engine 206, or manually identified as a positive indicator). Further, each of these attributes may be used together (e.g., as factors in a composite score). Similarly, negative members may be identified as members that have not initiated campaigns, or that have had campaigns but at a low spending amount (e.g., below the certain spending amount), or who have had campaigns of low success (e.g., below the minimum threshold), or who had a small number of campaigns but then ceased advertising (e.g., no new campaigns within a certain pre-determined period of time).

As such, the target offering data module 320 constructs or otherwise identifies the positive and negative sets of members (training members). The target offering data module 320 passes the positive and negative sets on to the skills identification module 330 for further processing.

The skills identification module 330 identifies skills of the members identified in the target offering data 232 (e.g., the training members from the positive and negative sets). In some embodiments, the skills identification module 330 retrieves skill information, or skill sets, of the training members from the skills data 218 database (e.g., retrieved based on the member IDs from the positive and negative sets). In some embodiments, the skills identification module 330 determines skills data 218 from member attribute data (e.g., from profile data 212). As such, the skills identification module 330 adds the skills data to the training member data which, together with the training member classification data (e.g., positive or negative), is referred to herein as training data, or training members' data.

The skills analysis module 340 analyzes the skills data of the positive set members and negative set members to determine a target set of skills that may be used to generate higher-value leads for the marketer. In the example embodiment, the skills analysis module 340 implements a logistic regression model to identify skills that are probative of higher-value leads for the marketer based on the skill sets of the members identified in the positive set and negative set.

For example, presume that the positive and negative sets of members (training members) includes the following members having the following skill sets:

TABLE 1
Example Training Members' Skill Sets and Classification

| Skill Name/ | Positive | Positive | Negative | Negative |
|---|---|---|---|---|
| ID | Member #1 | Member #2 | Member #1 | Member #2 |
| Skill A | Yes | No | No | Yes |
| Skill B | Yes | Yes | No | No |
| Skill C | No | Yes | Yes | No |
| Skill D | Yes | Yes | No | No |
| Skill E | No | No | No | Yes |
| Skill F | No | No | Yes | Yes |

In Table 1, an identifier of “Yes” indicates that the particular member of that associated column has the skill of the associated row (e.g., having self-identified as having that skill, or determined as having that skill through analysis of member data), where an indicator of “No” indicates that the particular member of that associated column has not been identified as having the skill of the associated row (e.g., as an affirmative denial of that skill, or as an inferred lack of the skill from having not asserted or otherwise identified the skill for that member, or as a default value if the member does not have a “Yes” indicator for that skill). Further, a “positive” member is identified as one member classification, for purposes of the logistic regression, and a “negative” member is a second member classification. In other words, the training members are identified (e.g., classified) as either a positive member or a negative member. It should be understood that some members may have dozens or hundreds of skills and that only example Skills A-F are shown here for ease of discussion. Further, it should be understood that the positive and negative sets of members may include many more members, or any number of members, and that only two members are shown for each set in Table 1 for ease of discussion.

In one example embodiment, the skills analysis module 340 performs logistic regression using training data such as the above example skill sets and classifications shown in Table 1. More specifically, the logistic regression analysis includes training a binary logistic model based on the training members' data. For purposes of the logistic regression analysis, the member classification as either “positive” or “negative” is the categorical dependent variable of the model, and each of the skills of the training members are independent variables. As such, the training members' data identifies binary values for the member classification for each training member (e.g., positive or negative classification), as well as the associated skill set of each training member. The skills analysis module 240 thus trains the model based on this data. Accordingly, the resulting model takes a skill set (e.g., of a prospect member) as inputs and generates a classification probability or prospect score (e.g., how likely it is that the prospect member is a positive classification) as output.

In some embodiments, the skills analysis module 340 analyzes target offering data that includes communication channel data. For example, the target offering data may identify multiple positive sets and/or negative sets, where each positive and/or negative set is segmented by, or otherwise individualized for a particular communications channel of the social network system 210. As such, the skills analysis module 340 may generate target skills for the target offering specific to each of the communication channels. In other words, the skills analysis module 340 may yield a first set of target skills for the target offering within one communications channel (e.g., text ads) and a second set of target skills for the target offering within another communications channel (e.g., sponsored updates). The skills analysis module 340 performs the logistic regression for each of the communications channels' positive and/or negative sets independently of each other, thus generating multiple, separate models for the target offering, one for each communications channel.

The campaign module 350 then applies the model(s) computed by the skills analysis module 340 to other members of the social network system 210 (e.g., prospective leads). More specifically, the campaign module 350 applies one or more members' skills information to the model(s) to compute a prospect score for that member (e.g., a probability whether that member would be classified as “positive,” based on the model). Higher prospect scores generally indicate higher-value prospective leads. Application of the model to all members of the social network system 210 may be computationally unappealing. As such, in some embodiments, the campaign module 350 may identify a subset of members for scoring with the model (e.g., preliminarily pruning or identifying just some portion of the members of the social network service 210). For example, the campaign module 350 may identify the subset of members based on one or more skills (e.g., those members identifying skills associated with marketing, or perhaps having a highly-influential skill identified as described herein), or based on member profile information (e.g., those members indicating “marketing” in their job titles), or based on demographics. Once the subset of members has been identified, the campaign module 350 may apply just this subset of members to the model. This preliminary identification of higher-prospect leads may allow for a computationally more efficient identification of more likely prospects (e.g., from a simple single-variable examination) prior to the more computationally burdensome application of the member to the full model (e.g., applying many variables of the member to the model).

In some embodiments, the campaign module 350 also ranks the members based on their prospect score and presents a subset of scored members to the marketer (e.g., through the marketer interface module 310). In some embodiments, all prospect members having a prospect score above a pre-determined threshold are provided to the marketer. In other embodiments, a pre-determined number of prospect members are provided to the marketer. In some embodiments, the prospect score may also be provided to the marketer. In some embodiments, the campaign module 350 may identify a market size based on the number of positive members identified by the model, or how much revenue may be anticipated by a campaign based on the nature of the positive members identified by the model, or may enable the marketer to target prospects based on the prospect score (e.g., through the communications channels, or external to the social network system 210). In some embodiments, the prospect score may be provided as a factor to another composite scoring engine for advertising prospects.

In some embodiments, the campaign module 350 may present multiple prospect scores for each prospect member, one prospect score for each communications channel model. As such, the marketer or the skills analysis engine 206 may identify a relative prediction for each particular communications channel (e.g., where sponsored updates may present a higher probability to generate a positive lead than a text advertisement).

In some embodiments, the campaign module 350 may identify and/or rank skills that are influential after applying the model. In other words, once the model is constructed and used across a set of members, or “resultant members,” those members indicated as positive by the model may be analyzed as to their skills as compared to the members indicated as negative by the model. Skills that are more prevalent in the resultant positive members and simultaneously more scarce in the resultant negative members represent skills that are more influential in determining positivity within members. For example, presume the training members' skill data shown in Table 1 instead represents resultant positive and negative members' skill data (e.g., identified by the model as positive members #1 and #2, and negative members #1 and #2). Because the skills B and D are present in the resultant positive members but not present in the resultant negative members, those skills B and D would be identified by the campaign module 350 as influential to determining positivity. In some embodiments, this post-model analysis and ranking, and the subsequent identification of positive skills or negative skills may be used to refine the model. For example, the model may be reconstructed or otherwise altered to include the identified positive or negative skills in the determination of which members are selected as a part of the positive and/or negative sets. As such, the model may identify influential skills not previously included as factors in building the model, and subsequently may use those skills as factors to further refine its output.

FIG. 4 is a flow chart illustrating operations of the skills analysis engine 206 in performing a method 400 for providing targeting analysis with skills data in a social network, according to various embodiments. Operations in the method 400 may be performed by the network-based system 105, using modules described above with respect to FIG. 3. As shown in FIG. 4, the method 400 includes operations 410, 420, 430, and 440.

At operation 410, the method 400 includes identifying a first set of members on a social network, each member of the first set of members includes a class value comprising one of a positive member and a negative member, each positive member is associated with a target offering. In some embodiments, identifying a first set of members includes receiving the set of members from a marketer of the target offering. In some embodiments, identifying a first set of members further includes receiving a first skill and identifying one or more members having the first skill to include in the first set of members. In some embodiments, the target offering is advertising services offered by the social network, wherein each positive member is classified as positive based on historical interaction by the positive member with the target offering. In some embodiments, the advertising services of the target offering is a single communications channel of a plurality of communications channels provided by the social network.

At operation 420, the method 400 includes determining, from the memory, a skillset of each member of the first set of members. At operation 430, the method 400 includes training, by the processor, a first model based on the class value and skillset of each member of the first set of members, the first model configured to generate at least one of a classification value and a prospect score for a prospect member based on a prospect member skillset. In some embodiments, the first set of members is segmented based on a first communications channel of the social network, and the method 400 further includes training a second model based on a second set of members, wherein the second set of members is segmented based on a second communications channel of the social network.

At operation 440, the method 400 further includes computing a prospect score for the prospect member using the first model and the prospect member skillset. At operation 450, the method 400 also includes providing the at least one of a classification value and a prospect score for use in evaluating the prospect member in relation to the target offering. In some embodiments, the method also includes identifying a second set of members on the social network site, applying the second set of members to the model, and identifying a positive skill based on the results of applying the second set of members to the model.

FIG. 5 is a block diagram illustrating components of a machine 500, according to some example embodiments, able to read instructions 524 from a machine-readable medium 522 (e.g., a non-transitory machine-readable medium, a machine-readable storage medium, a computer-readable storage medium, or any suitable combination thereof) and perform any one or more of the methodologies discussed herein, in whole or in part. In some embodiments, the machine 500 is similar to the networked system 105, or the social network system 210, or the lead generation module 206. Specifically, FIG. 5 shows the machine 500 in the example form of a computer system (e.g., a computer) within which the instructions 524 (e.g., software, a program, an application, an applet, an app, or other executable code) for causing the machine 500 to perform any one or more of the methodologies discussed herein may be executed, in whole or in part.

In alternative embodiments, the machine 500 operates as a standalone device 130, 150 or may be connected (e.g., networked) to other machines. In a networked deployment, the machine 500 may operate in the capacity of a server machine 110 or a client machine in a server-client network environment, or as a peer machine in a distributed (e.g., peer-to-peer) network environment. The machine 500 may be a server computer, a client computer, a personal computer (PC), a tablet computer, a laptop computer, a netbook, a cellular telephone, a smartphone, a set-top box (STB), a personal digital assistant (PDA), a web appliance, a network router, a network switch, a network bridge, or any machine capable of executing the instructions 524, sequentially or otherwise, that specify actions to be taken by that machine. Further, while only a single machine 500 is illustrated, the term “machine” shall also be taken to include any collection of machines 500 that individually or jointly execute the instructions 524 to perform all or part of any one or more of the methodologies discussed herein.

The machine 500 includes a processor 502 (e.g., a central processing unit (CPU), a graphics processing unit (GPU), a digital signal processor (DSP), an application specific integrated circuit (ASIC), a radio-frequency integrated circuit (RFIC), or any suitable combination thereof), a main memory 504, and a static memory 506, which are configured to communicate with each other via a bus 508. The processor 502 may contain microcircuits that are configurable, temporarily or permanently, by some or all of the instructions 524 such that the processor 502 is configurable to perform any one or more of the methodologies described herein, in whole or in part. For example, a set of one or more microcircuits of the processor 502 may be configurable to execute one or more modules (e.g., software modules) described herein.

The machine 500 may further include a graphics display 510 (e.g., a plasma display panel (PDP), a light emitting diode (LED) display, a liquid crystal display (LCD), a projector, a cathode ray tube (CRT), or any other display capable of displaying graphics or video). The machine 500 may also include an alphanumeric input device 512 (e.g., a keyboard or keypad), a cursor control device 514 (e.g., a mouse, a touchpad, a trackball, a joystick, a motion sensor, an eye tracking device, or another pointing instrument), a storage unit 516, an audio generation device 518 (e.g., a sound card, an amplifier, a speaker, a headphone jack, or any suitable combination thereof), and a network interface device 520.

The storage unit 516 includes the machine-readable medium 522 (e.g., a tangible and non-transitory machine-readable storage medium) on which are stored the instructions 524 embodying any one or more of the methodologies or functions described herein. The instructions 524 may also reside, completely or at least partially, within the main memory 504, within the processor 502 (e.g., within the processor's cache memory), or both, before or during execution thereof by the machine 500. Accordingly, the main memory 504 and the processor 502 may be considered machine-readable media 522 (e.g., tangible and non-transitory machine-readable media). The instructions 524 may be transmitted or received over the network 190 via the network interface device 520. For example, the network interface device 520 may communicate the instructions 524 using any one or more transfer protocols (e.g., Hypertext Transfer Protocol (HTTP)).

In some example embodiments, the machine 500 may be a portable computing device, such as a smartphone or tablet computer, and may have one or more additional input components 530 (e.g., sensors or gauges). Examples of such input components 530 include an image input component (e.g., one or more cameras), an audio input component (e.g., a microphone), a direction input component (e.g., a compass), a location input component (e.g., a global positioning system (GPS) receiver), an orientation component (e.g., a gyroscope), a motion detection component (e.g., one or more accelerometers), an altitude detection component (e.g., an altimeter), and a gas detection component (e.g., a gas sensor). Inputs harvested by any one or more of these input components 530 may be accessible and available for use by any of the modules described herein.

As used herein, the term “memory” refers to a machine-readable medium 522 able to store data temporarily or permanently and may be taken to include, but not be limited to, random-access memory (RAM), read-only memory (ROM), buffer memory, flash memory, and cache memory. While the machine-readable medium 522 is shown in an example embodiment to be a single medium, the term “machine-readable medium” should be taken to include a single medium or multiple media (e.g., a centralized or distributed database, or associated caches and servers) able to store instructions 524. The term “machine-readable medium” shall also be taken to include any medium, or combination of multiple media, that is capable of storing the instructions 524 for execution by the machine 500, such that the instructions 524, when executed by one or more processors of the machine 500 (e.g., processor 502), cause the machine 500 to perform any one or more of the methodologies described herein, in whole or in part. Accordingly, a “machine-readable medium” refers to a single storage apparatus or device, as well as cloud-based storage systems or storage networks that include multiple storage apparatus or devices. The term “machine-readable medium” shall accordingly be taken to include, but not be limited to, one or more tangible (e.g., non-transitory) data repositories in the form of a solid-state memory, an optical medium, a magnetic medium, or any suitable combination thereof.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments are described herein as including logic or a number of components, modules, engines, or mechanisms. Modules or engines may constitute software modules (e.g., code stored or otherwise embodied on a machine-readable medium 522 or in a transmission medium), hardware modules, or any suitable combination thereof. A “hardware module” is a tangible (e.g., non-transitory) unit capable of performing certain operations and may be configured or arranged in a certain physical manner. In various example embodiments, one or more computer systems (e.g., a standalone computer system, a client computer system, or a server computer system) or one or more hardware modules of a computer system (e.g., a processor or a group of processors 502) may be configured by software (e.g., an application or application portion) as a hardware module that operates to perform certain operations as described herein.

In some embodiments, a hardware module may be implemented mechanically, electronically, or any suitable combination thereof. For example, a hardware module may include dedicated circuitry or logic that is permanently configured to perform certain operations. For example, a hardware module may be a special-purpose processor, such as a field programmable gate array (FPGA) or an ASIC. A hardware module may also include programmable logic or circuitry that is temporarily configured by software to perform certain operations. For example, a hardware module may include software encompassed within a general-purpose processor 502 or other programmable processor 502. It will be appreciated that the decision to implement a hardware module mechanically, in dedicated and permanently configured circuitry, or in temporarily configured circuitry (e.g., configured by software) may be driven by cost and time considerations.

Accordingly, the phrase “hardware module” should be understood to encompass a tangible entity, and such a tangible entity may be physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where a hardware module comprises a general-purpose processor 502 configured by software to become a special-purpose processor, the general-purpose processor 502 may be configured as respectively different special-purpose processors (e.g., comprising different hardware modules) at different times. Software (e.g., a software module) may accordingly configure one or more processors 502, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple hardware modules exist contemporaneously, communications may be achieved through signal transmission (e.g., over appropriate circuits and buses 508) between or among two or more of the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors 502 that are temporarily configured (e.g., by software) or permanently configured to perform the relevant operations. Whether temporarily or permanently configured, such processors 502 may constitute processor-implemented modules that operate to perform one or more operations or functions described herein. As used herein, “processor-implemented module” refers to a hardware module implemented using one or more processors 502.

Similarly, the methods described herein may be at least partially processor-implemented, a processor 502 being an example of hardware. For example, at least some of the operations of a method may be performed by one or more processors 502 or processor-implemented modules. As used herein, “processor-implemented module” refers to a hardware module in which the hardware includes one or more processors 502. Moreover, the one or more processors 502 may also operate to support performance of the relevant operations in a “cloud computing” environment or as a “software as a service” (SaaS). For example, at least some of the operations may be performed by a group of computers (as examples of machines 500 including processors 502), with these operations being accessible via a network 190 (e.g., the Internet) and via one or more appropriate interfaces (e.g., an application programming interface (API)).

The performance of certain operations may be distributed among the one or more processors 502, not only residing within a single machine 500, but deployed across a number of machines 500. In some example embodiments, the one or more processors 502 or processor-implemented modules may be located in a single geographic location (e.g., within a home environment, an office environment, or a server farm). In other example embodiments, the one or more processors 502 or processor-implemented modules may be distributed across a number of geographic locations.

Some portions of the subject matter discussed herein may be presented in terms of algorithms or symbolic representations of operations on data stored as bits or binary digital signals within a machine memory (e.g., a computer memory). Such algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine 500. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine 500 (e.g., a computer) that manipulates or transforms data represented as physical (e.g., electronic, magnetic, or optical) quantities within one or more memories (e.g., volatile memory, non-volatile memory, or any suitable combination thereof), registers, or other machine components that receive, store, transmit, or display information. Furthermore, unless specifically stated otherwise, the terms “a” or “an” are herein used, as is common in patent documents, to include one or more than one instance. Finally, as used herein, the conjunction “or” refers to a non-exclusive “or,” unless specifically stated otherwise.

What is claimed is:

1. A computer-implemented method performed using a processor and a memory, the method comprising:
identifying a first set of members on a social network, each member of the first set of members includes a class value comprising one of a positive member and a negative member, each positive member is associated with a target offering;
determining, from the memory, a skillset of each member of the first set of members;
training, by the processor, a first model based on the class value and skillset of each member of the first set of members, the first model configured to generate at least one of a classification value and a prospect score for a prospect member based on a prospect member skillset;
computing a prospect score for the prospect member using the first model and the prospect member skillset; and
providing the at least one of a classification value and a prospect score for use in evaluating the prospect member in relation to the target offering.

2. The method of claim 1, wherein identifying a first set of members includes receiving the set of members from a marketer of the target offering.

3. The method of claim 1, wherein identifying a first set of members further includes:
receiving a first skill; and
identifying one or more members having the first skill to include in the first set of members.

4. The method of claim 1, wherein the first set of members is segmented based on a first communications channel of the social network, the method further comprising:
training a second model based on a second set of members, wherein the second set of members is segmented based on a second communications channel of the social network.

5. The method of claim 1, wherein the target offering is advertising services offered by the social network, wherein each positive member is classified as positive based on historical interaction by the positive member with the target offering.

6. The method of claim 5, wherein the advertising services of the target offering is a single communications channel of a plurality of communications channels provided by the social network.

7. The method of claim 1 further comprising:
identifying a second set of members on the social network site;
applying the second set of members to the model; and
identifying a positive skill based on the results of applying the second set of members to the model.

8. A social network system comprising:
a first database having skill data for a first set of members on a social network;
one or more processors configured by a skills analysis engine to:
identify the first set of members on a social network, each member of the first set of members includes a class value comprising one of a positive member and a negative member, each positive member is associated with a target offering;
determine a skillset of each member of the first set of members from the skill data;
train a first model based on the class value and skillset of each member of the first set of members, the first model configured to generate at least one of a classification value and a prospect score for a prospect member based on a prospect member skillset;
compute a prospect score for the prospect member using the first model and the prospect member skillset; and
provide the at least one of a classification value and a prospect score for use in evaluating the prospect member in relation to the target offering.

9. The social network system of claim 8, wherein identifying a first set of members includes receiving the set of members from a marketer of the target offering.

10. The social network system of claim 8, wherein identifying a first set of members further includes:
receiving a first skill; and
identifying one or more members having the first skill to include in the first set of members.

11. The social network system of claim 8, wherein the first set of members is segmented based on a first communications channel of the social network, wherein the one or more processors are further configured by the skills analysis engine to:
train a second model based on a second set of members, wherein the second set of members is segmented based on a second communications channel of the social network.

12. The social network system of claim 8, wherein the target offering is advertising services offered by the social network, wherein each positive member is classified as positive based on historical interaction by the positive member with the target offering.

13. The social network system of claim 12, wherein the advertising services of the target offering is a single communications channel of a plurality of communications channels provided by the social network system.

14. The social network system of claim 8, wherein the one or more processors are further configured by the skills analysis engine to:
identify a second set of members on the social network site;
apply the second set of members to the model; and
identify a positive skill based on the results of applying the second set of members to the model.

15. A non-transitory machine-readable storage medium comprising instructions that, when executed by one or more processors of a machine, cause the machine to perform operations comprising:
identifying a first set of members on a social network, each member of the first set of members includes a class value comprising one of a positive member and a negative member, each positive member is associated with a target offering;
determining a skillset of each member of the first set of members;
training a first model based on the class value and skillset of each member of the first set of members, the first model configured to generate at least one of a classification value and a prospect score for a prospect member based on a prospect member skillset;
computing a prospect score for the prospect member using the first model and the prospect member skillset; and
providing the at least one of a classification value and a prospect score for use in evaluating the prospect member in relation to the target offering.

16. The storage medium of claim 15, wherein identifying a first set of members includes receiving the set of members from a marketer of the target offering.

17. The storage medium of claim 15, wherein identifying a first set of members further includes:
receiving a first skill; and
identifying one or more members having the first skill to include in the first set of members.

18. The storage medium of claim 15, wherein the first set of members is segmented based on a first communications channel of the social network, wherein the instructions further cause the machine to perform operations comprising:
training a second model based on a second set of members, wherein the second set of members is segmented based on a second communications channel of the social network.

19. The storage medium of claim 15, wherein the target offering is advertising services offered by the social network, wherein each positive member is classified as positive based on historical interaction by the positive member with the target offering.

20. The storage medium of claim 15, wherein the instructions further cause the machine to perform operations comprising:
identifying a second set of members on the social network site;
applying the second set of members to the model; and
means for identifying a positive skill based on the results of applying the second set of members to the model.
